(19) United States
(12) Patent Application Publication
(10) Pub. No.: US 2011/0024524 A1
(43) Pub. Date: Feb. 3, 2011

(54) DISPOSABLE SPRAY GUN CARTRIDGE

(76) Inventor: Jeffrey D. Fox, Nerstrand, MN (US)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/920,841

(22) PCT Filed: Mar. 12, 2008
(86) PCT No.: PCT/US08/03318

§ 371 Date: Oct. 22, 2010

(51) Int. Cl. B05B 7/00

(52) U.S. Cl. 239/302

(57) ABSTRACT

A disposable cartridge assembly for use with a paint spray gun is disclosed, being made out of an inexpensive material, such as plastic, wherein the paint flows into the cartridge assembly and is sucked out of the tip of the cartridge assembly by the force of pressurized air flowing around the cartridge assembly and past the cartridge assembly fluid spray tip opening, thereby atomizing the paint, allowing for an even application of the paint onto a working surface, such as an automobile body. The inexpensive material allows the cartridge to be disposed of after use, rather than cleaned. Further, keeping the paint within the cartridge assembly and away from any inner workings of the paint spray gun reduces or eliminates the need to clean the spray gun after use.

### BACKGROUND OF THE INVENTION

I. Field of the Invention

This invention relates to improvements to a hand-held spray gun, specifically designed to be used with a cartridge assembly, such as those used for applying paint, and more particularly to the disposability of the spray gun cartridge.

II. Discussion of the Prior Art

Spray guns are widely used in painting applications where even application of paint is required over fairly wide areas, such as motor vehicles when painting a vehicle following repair after an accident. Typically, in spray guns, the liquid is contained in a reservoir attached to the spray gun from which the liquid is fed to a spray nozzle. At the spray nozzle, compressed air atomizes the liquid into a spray which is then applied to the surface being painted. The liquid may be gravity fed, suction fed or even pressure fed by an air bleed line to the reservoir from the compressed air line to the spray gun.

Traditionally, paint spray guns and paint spraying equipment must be thoroughly cleaned after each use, and much time is spent properly cleaning the equipment and parts of the spray gun. Solvent costs and the disposable waste generated by cleaning the spray gun add additional expense and waste. The present invention substantially reduces, and may even eliminate, that cost and waste.

Traditional spray guns also have set fluid tip sizes or, if adjustable, must be thoroughly cleaned after each use. The present invention can be made in varying fluid tip sizes depending upon the application or painting project and do not require cleaning after use.

### SUMMARY OF THE INVENTION

The present invention provides a spray gun with a disposable cartridge assembly, the cartridge assembly body being a hollow tube structure with an inner and an outer surface area, a reservoir connector, a fluid spray tip and fluid spray tip opening and a cap end opening, and further having a fluid needle, a fluid needle seal, a fluid needle washer, a fluid compression spring, an E-clip and a cap. The cartridge assembly would fit within a typical spray gun and be easily removable for disposal after its use. The cartridge assembly could also have various shapes and sizes to fit within a variety of spray guns. A reservoir would deliver liquid, such as paint, a chemical, a stain, a varnish or other sprayable liquid to the cartridge assembly through a reservoir connector and into the hollow body of the cartridge assembly. Pressurized air would flow into the spray gun, around the cartridge assembly and out the spray tip of the spray gun, thereby forcibly siphoning the liquid out of the cartridge assembly and atomizing the liquid for application onto the surface being sprayed. The reservoir holding the liquid could be attached to the cartridge assembly by the reservoir connector inlet opening, or the liquid could be delivered by tubing or some other means to the cartridge assembly. The reservoir connector inlet opening configuration would vary to match the particular type of reservoir or fluid hose from which the liquid would enter the cartridge assembly. The cartridge assembly body, fluid needle and cap could be made of a variety of inexpensive materials, such as plastic, metal, an alloy or some sturdy recycled material.

### BRIEF DESCRIPTION OF THE DRAWINGS

FIG. 1 is a cut-away view of the cartridge assembly;

FIG. 2 is an exploded view of the cartridge assembly; and

FIG. 3 is a cut-away view of a typical spray gun with the cartridge assembly contained therein.

### DETAILED DESCRIPTION OF THE DRAWINGS

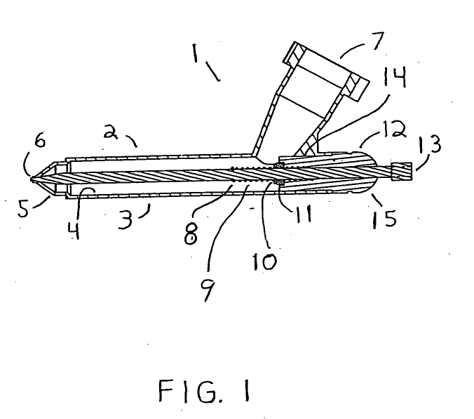

Referring to FIG. 1, the cartridge assembly 1 is shown cut in half lengthwise. The cartridge assembly 1 comprises a body 2, an outer surface 3, an inner surface 4, a tapered fluid spray tip 5, a fluid spray tip opening 6 and a connector inlet opening 7.

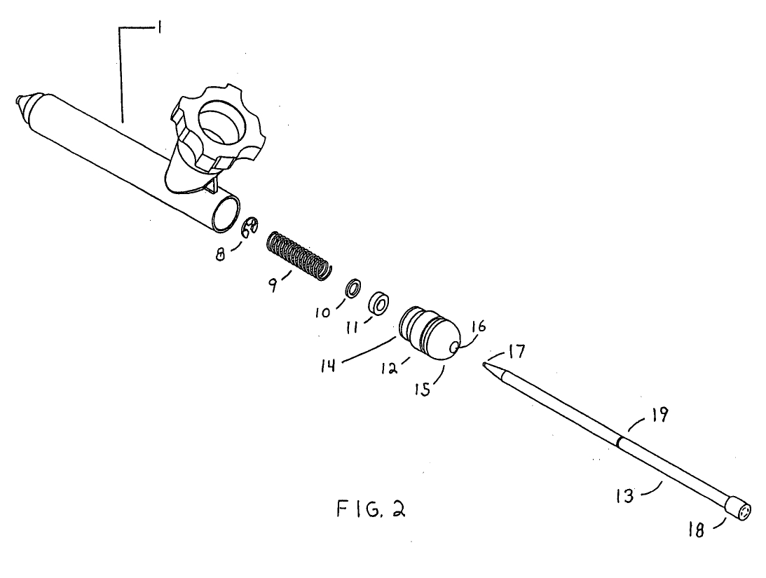

Referring now to FIG. 2, the cartridge assembly 1 is shown in exploded view, further comprising an E-clip 8, a fluid compression spring 9, a fluid needle washer 10, a fluid needle seal 11, a fluid cartridge end cap 12 and a fluid needle 13. The cartridge end cap 12 further comprises a fitting end 14 and a needle adjustment end 15. The cartridge end cap 12 further comprises a bore 16 from the fitting end 14 to the needle adjustment end 15. The bore 16 is of sufficient diameter to allow the fluid needle 13 to slide through the cartridge end cap 12.

Referring still to FIG. 2, the fluid needle 13 comprises a tapered spray tip end 17, a control end 18 and an annular groove 19 about midway between the tapered spray tip end 17 and the control end 18. The fluid needle 13 has a diameter slightly smaller than the diameter of the cartridge end cap bore 16, such that the fluid needle 17 can slide within the bore 16 through the fluid cartridge end cap 12. The control end 18 has a diameter larger than the cap bore 16 to prevent the fluid needle 13 from passing entirely through the fluid cartridge end cap 12. In operation, the fluid needle 13 slides through the fluid cartridge end cap 12, tapered spray tip end 17 first through the needle adjustment end 18, the fluid needle seal 11 is situated around the fluid needle 13 and fits snugly inside the fluid cartridge end cap 12, thereby preventing the flow of liquid out through the bore 16, after which the fluid needle washer 10 is placed on the fluid needle 13, then the fluid compression spring 9 is placed on the fluid needle 13, and the e-clip 8 is fastened around the fluid needle 13 in the annular groove 19, thereby preventing the fluid compression spring 9 and the fluid needle washer 10 from sliding off the fluid needle 13. The fluid cartridge end cap 12 is then attached to the body 2 by inserting the fitting end 14 into the body 2 and securing the fluid end cap 12 to the body 2 with adhesive means. Friction can also hold the fluid end cap 12 onto the body 2 by having the fitting end be of sufficiently large diameter to fit snugly within the inner surface 4 of the body 2.

Referring again to FIG. 1, the cartridge assembly 1 is shown with the fluid needle 13 in its at rest position, wherein the tapered spray tip end 17 of the fluid needle 13 is seated within the fluid spray tip opening 6. While in its at rest position, no liquid can escape the cartridge assembly 1. In operation, the fluid needle 13 would be pulled out slightly from its seated position, thereby allowing liquid to escape through the fluid spray tip opening 6. A reservoir for fluid (not shown) would be attached to the reservoir connector inlet opening 7, allowing liquid to feed into the cartridge assembly 1 by means of gravity.

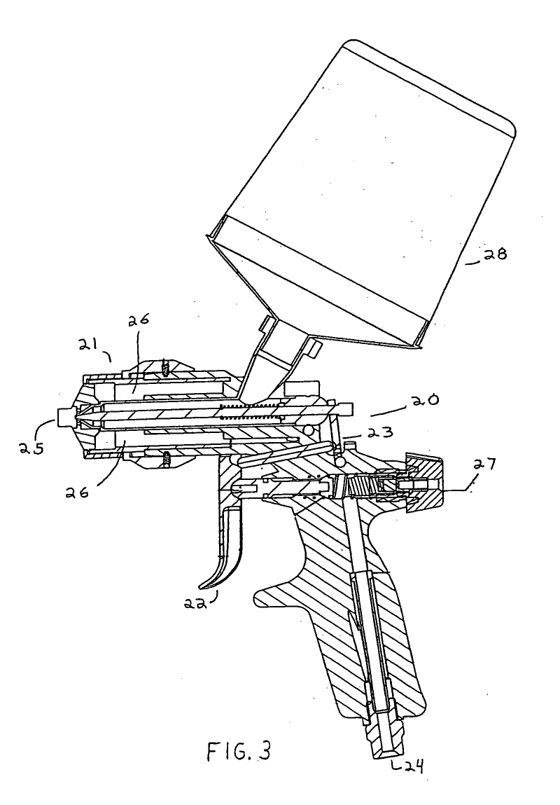

Referring to FIG. 3, a spray gun 20 is shown with the cartridge assembly 1 in place and the reservoir 28 attached to the reservoir connector inlet opening 7 of the cartridge assembly 1. In operation, the cartridge assembly fits within the barrel 21 of the spray gun 20 with the reservoir connector inlet opening 7 protruding from the barrel 21, such that a seal is formed around the reservoir connector inlet opening 7 to prevent the flow of air out of the barrel 21 around the reservoir connector inlet opening 7. The spray gun 20 comprises a trigger 22 that controls the amount of pressurized air flowing into the barrel 21 of the spray gun 20, a lever assembly 23, an inlet air port 24 and a nozzle 25. The trigger 22 is attached to the lever assembly 23 that actuates the fluid needle 13, moving the fluid needle 13 from its at rest position, thereby unseating the tapered spray tip end 17 of the fluid needle 13 from the fluid spray tip opening 6. Pressurized air flows into the spray gun 20 through an inlet air port 24 and flows through the spray gun 20, exiting the nozzle 25. The cartridge assembly 1 fits within the barrel 21 of the spray gun 20 such that there exists a space 26 around the cartridge assembly 1, allowing the pressurized air to flow around and past the cartridge assembly 1, exiting at the nozzle 25 of the spray gun 20. As the trigger 22 is pulled, the fluid needle 13 is moved out of its seated at rest position, thereby allowing liquid fed by gravity from the reservoir 28 to the cartridge assembly 1 to escape from the fluid spray tip opening 6 and become atomized by the pressurized air flowing out of the nozzle 25 of the spray gun 20. A fluid adjuster knob 27, movably attached to the spray gun 20, limits the movement of the trigger 22, thereby controlling the amount of pressurized air entering the spray gun 20, which controls the amount of liquid escaping from the cartridge assembly 1. The amount of liquid that is sucked out of the fluid spray tip opening 6 of the cartridge assembly 1 is determined by the flow of pressurized air flowing past the fluid spray tip opening 6. The stronger the flow of pressurized air, the more liquid is sucked out of the fluid spray tip opening 6. The fluid spray tip opening 6 would have a diameter of sufficient size to suit the type of liquid being applied. Thinner liquids would require a smaller diameter fluid spray tip opening 6 while thicker liquids would require a larger diameter fluid spray tip opening 6.

No liquid touches any inner part of the spray gun 20, thus allowing for easy clean up after use. The cartridge assembly 1 and its components can be made of any number of inexpensive materials, such as plastic, thereby allowing the user to dispose of the cartridge assembly 1 after its use, thus substantially reducing or eliminating any cleaning.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1-18. (canceled)

19. A disposable cartridge assembly (1) for use in spray guns comprising:
a tubular body (2) having at one end a fluid spray tip (5) with a fluid spray tip opening (6) to permit fluids to pass therethrough and at the other end an end cap (12) with a bore (16) therethrough,
a connector inlet opening (7) formed in a sidewall of the body (2) for connecting the cartridge assembly (1) to a fluid supply reservoir (28) for feeding a fluid into the cartridge assembly (1),
a needle (13) slideably engaging through the bore (16) of the end cap (12) and having a tapered end (17) for engaging the spray tip opening (6), whereby the needle (13) can be moved to allow a variable fluid flow out of the spray tip opening (6) and/or to block the fluid flow therethrough,
wherein a fluid needle seal (11) is situated around the fluid needle (13) and fits snugly inside the end cap (12) thereby preventing the flow of fluid out through the bore (16) in the end cap (12).

20. A disposable cartridge assembly for use in spray guns as in claim 19, having a spring (9) arranged inside the tubular body (2) and biasing the needle (13) for engaging its tapered end (17) into the spray tip opening (6) to stop fluid flow therethrough.

21. A disposable cartridge assembly for use in spray guns as in claim 20, wherein the spring (9) surrounds the needle (13) on the inside of the tubular body (2).

22. A disposable cartridge assembly for use in spray guns as in claim 21, wherein the needle (13) comprises a control end (18) arranged outside the tubular body (2) and an annular groove (19) arranged between the tapered end (17) and the control end (18).

23. A disposable cartridge assembly for use in spray guns as in claim 22, wherein an e-clip (8) is fastened around the fluid needle (13) in the annular groove (19) thereby preventing the spring (9) from sliding off the fluid needle (13).

24. A disposable cartridge assembly for use in spray guns as in claim 19, wherein the tubular body (2) and/or the needle (13) are made of plastic.

25. A spray gun (20) comprising a housing, an air inlet port (24), a nozzle (25), a disposable cartridge assembly (1) according to claim 19 and a fluid reservoir (28) connected to the connector inlet opening (7) of the cartridge assembly (1), wherein pressurized air can flow through the air inlet port (24) into the spray gun (20) and is exiting the nozzle (25) thereby atomizing the fluid escaping from the spray tip opening (6) of the cartridge (1).

26. A spray gun as in claim 25, wherein the spray gun comprises a barrel (21) in which the cartridge assembly (1) is removably fitting.

27. A spray gun as in claim 26, wherein the cartridge assembly (1) is removably fitting in the barrel (21) of the spray gun (20) such that there exists a space (26) around the cartridge assembly (1) allowing the pressurized air to flow around and past the cartridge assembly (1) and exiting at the nozzle (25).

28. A spray gun as in claim 25, wherein the spray gun further comprises a trigger (22) controlling the amount of pressurized air flowing into the spray gun (20).

29. A spray gun as in claim 28, wherein the trigger (22) is attached to a lever assembly (23) actuating the fluid needle (13) such that the fluid needle (13) can be disengaged from its at rest position wherein its tapered end (17) is seated within the spray tip opening (6) into a position allowing fluid to escape through the spray tip opening (6).
